(19) United States
(12) Patent Application Publication
(10) Pub. No.: US 2026/0322171 A1
(43) Pub. Date: Oct. 15, 2026

(54) NON-CONTACT POWER SUPPLY DEVICE AND POWER RECEPTION DEVICE

(71) Applicant: OMRON Corporation, KYOTO (JP)

(72) Inventors: Goro NAKAO, Kyoto-shi, KYOTO (JP); Yuki ITO, Kyoto-shi, KYOTO (JP); Taichi MISHIMA, Kyoto-shi, KYOTO (JP); Hiroyuki IBUKI, Kyoto-shi, KYOTO (JP); Koji MORITA, Kyoto-shi, KYOTO (JP); Yoshihisa ISHIKAWA, Kyoto-shi, KYOTO (JP)

(73) Assignee: OMRON Corporation, KYOTO (JP)

(21) Appl. No.: 19/484,367

(22) PCT Filed: May 17, 2024
(86) PCT No.: PCT/JP2024/018272

§ 371 Date: Nov. 14, 2025

(30) Foreign Application Priority Data
Jun. 22, 2023 (JP) 2023-102466

(51) Int. Cl. H02J 50/12; H02J 50/00; H02J 50/40

(52) U.S. Cl. CPC H02J 50/12; H02J 50/005; H02J 50/402

(57) ABSTRACT

A power reception device 3 of a non-contact power supply device 1 has: resonance circuits (21-1 to 21-n) each having a reception coil 22 and a resonance capacitor 23 and receive power from a power transmission device 2 by resonance of the reception coil 22 with the resonance capacitor 23 with respect to AC power supplied to a transmission coil 12 of the power transmission device 2; and a load coil disposed to be electromagnetically coupled with the reception coil 22 of each resonance circuit and outputs power received from the power transmission device 2 by each resonance circuit. The reception coil 22 and the load coil 24 are formed as wiring patterns in different layers of a substrate 5 having layers and are connected to each other so that one end of the reception coil 22 and one end of the load coil 24 have the same potential.

### TECHNICAL FIELD

The invention relates to a non-contact power supply device and a power reception device used in the non-contact power supply device.

### RELATED ART

Conventionally, efforts have been made to study the so-called non-contact power supply (also referred to as wireless power supply) technology that transmits power through space without a metal contact or the like. In a power supply device using the non-contact power supply technology (hereinafter simply referred to as a non-contact power supply device), a coil on the primary side (power transmission side) (hereinafter referred to as a transmission coil or primary coil) and a coil of a resonant circuit on the secondary side (power reception side) (hereinafter referred to as a reception coil or secondary coil) are electromagnetically coupled, whereby power is transmitted from the device on the power transmission side to the device on the power reception side via the two coils.

In such non-contact power supply technology, a technology has been proposed that suppresses the between-terminal voltage of a resonant capacitor included in a resonant circuit of a power reception side device from becoming excessively high (for example, see Patent Document 1). In this technology, the power reception side device has multiple resonant circuits that receive power from the power transmission side device. Each of the resonant circuits has a reception coil and a resonant capacitor that resonates with the reception coil with respect to the AC power supplied to a transmission coil of the power transmission side device, and each of the reception coils is arranged to be able to electromagnetically couple each other.

### CITATION LIST

### Patent Document(s)

[Prior Art Document 1] Japan Patent Application Laid-open No. 2020-156218

### SUMMARY OF INVENTION

### Technical Problem

Depending on the application of the power reception side device, the device may need to be miniaturized. However, according to the technology, when multiple resonant circuits are provided in the power reception side device, lead wires are provided for the respective resonant circuits. Therefore, the wiring of the power reception side device becomes complicated, and as a result, the miniaturization of the power reception side device may be restricted.

Therefore, the invention aims to provide a non-contact power supply device that can simplify the wiring of the power reception side device.

### Solution to Problem

As an aspect of the invention, a non-contact power supply device is provided. The non-contact power supply device includes: a power transmission device; and a power reception device to which power is transmitted from the power transmission device in a non-contact manner. In the non-contact power supply device, the power transmission device includes: a transmission coil, supplying power to the power reception device; and a power supply circuit, supplying AC power to the transmission coil, and the power reception device includes: resonant circuits, the resonant circuit having a reception coil and a resonant capacitor and receiving power from the power transmission device through resonance of the reception coil and the resonant capacitor with respect to the AC power supplied to the transmission coil of the power transmission device; and a load coil, arranged to be able to be electromagnetically coupled to the reception coil of each of the resonant circuits and outputting the power received by each of the resonant circuits from the power transmission device. The reception coil of each of the resonant circuits and the load coil are formed as wiring patterns in layers different from each other in a substrate having multiple layers, and an end of the reception coil of each of the resonant circuits and an end of the load coil are connected to each other to have a same potential.

In the non-contact power supply device according to the invention, with such configuration, the wirings associated with the reception coil of each of the resonant circuits and the load coil in the power reception device can be reduced. Therefore, the wiring of the power reception device can be simplified.

In the non-contact power supply device, the end of the reception coil of each of the resonant circuits and the end of the load coil of the power reception device may be grounded. Accordingly, the resistance of the power reception device against noise can be improved.

In addition, in the non-contact power supply device, other ends of the reception coils of the respective resonant circuits of the power reception device may be separated from each other. Accordingly, even if the voltage generated through the power received by each resonant circuit differs, the power transmission efficiency is suppressed from decreasing.

In addition, in the non-contact power supply device, a number of turns of the load coil of the power reception device may be smaller than a total number of turns of the reception coils of the respective resonant circuits of the power reception device.

Accordingly, it is easy to operate each resonant circuit under a condition that the power transmission efficiency increases.

In addition, in the non-contact power supply device, the power reception device may further include: a DC-DC converter, operating to step down or step up a voltage output from the load coil; and a voltage detection circuit, operating the DC-DC converter when the voltage output from the load coil exceeds a predetermined threshold.

Accordingly, it is easy to operate each resonant circuit under a condition that the power transmission efficiency increases.

According to another embodiment, a power reception device is provided. The power reception device receives power transmitted from a transmission coil of a power transmission device in a non-contact manner. The power reception device includes: multiple resonant circuits, the resonant circuit having a reception coil and a resonant capacitor and receiving power from the power transmission device through resonance of the reception coil and the resonant capacitor with respect to AC power supplied to the transmission coil of the power transmission device; and a load coil, arranged to be able to be electromagnetically coupled to the reception coil of each of the resonant circuits and outputting the power received by each of the resonant circuits from the power transmission device. The reception coil of each of the resonant circuits and the load coil are formed as wiring patterns in layers different from each other in a substrate having multiple layers, and an end of the reception coil of each of the resonant circuits and an end of the load coil are connected to each other to have a same potential.

In the power reception device according to the invention, with such configuration, the wirings associated with the reception coil of each of the resonant circuits and the load coil in the power reception device can be reduced. Therefore, the wiring of the power reception device can be simplified.

### BRIEF DESCRIPTION OF DRAWINGS

FIG. 1 is a schematic configuration diagram of a non-contact power supply device according to an embodiment of the invention.

FIG. 2 is a schematic cross-sectional side view of a substrate on which a reception coil and a load coil of each resonant circuit are provided.

FIG. 3A is a schematic plan view showing the arrangement of the individual reception coils and load coils in one layer of the substrate, as viewed from the normal direction of a surface of the substrate.

FIG. 3B is a schematic plan view showing the arrangement of the individual reception coils and load coils in another layer of the substrate, as viewed from the normal direction of the surface of the substrate.

FIG. 3C is a schematic plan view showing the arrangement of individual reception coils and load coils in yet another layer of the substrate, as viewed from the normal direction of the surface of the substrate.

FIG. 3D is a schematic plan view showing the arrangement of individual reception coils and load coils in yet another layer of the substrate, as viewed from the normal direction of the surface of the substrate.

FIG. 4 is a diagram showing an example of operating properties of a DC-DC converter.

### DESCRIPTION OF EMBODIMENTS

Hereinafter, a non-contact power supply device according to an embodiment of the invention will be described with reference to the drawings. In this non-contact power supply device, a power reception side device (hereinafter simply referred to as a power reception device) has multiple resonant circuits that resonate with respect to AC power supplied to a transmission coil of a power transmission side device (hereinafter simply referred to as a power transmission device). Each resonant circuit of the power reception device has a reception coil and a resonant capacitor. The reception coil of each resonant circuit is arranged to be able to be electromagnetically coupled with respect to a load coil, and the power reception device outputs power received by each resonant circuit from the load coil. Furthermore, the reception coil and the load coil of each resonant circuit are respectively formed by wiring patterns in mutually different layers of a substrate having multiple layers. The reception coil of each resonant circuit and the load coil are connected to each other via a via of the substrate, so that one end of the reception coil of each resonant circuit and one end of the load coil have the same potential. In this way, by connecting the one end of the reception coil of each resonant circuit and the one end of the load coil to each other so that the one ends have the same potential, preferably so that they are grounded, the wiring of the power reception device is simplified.

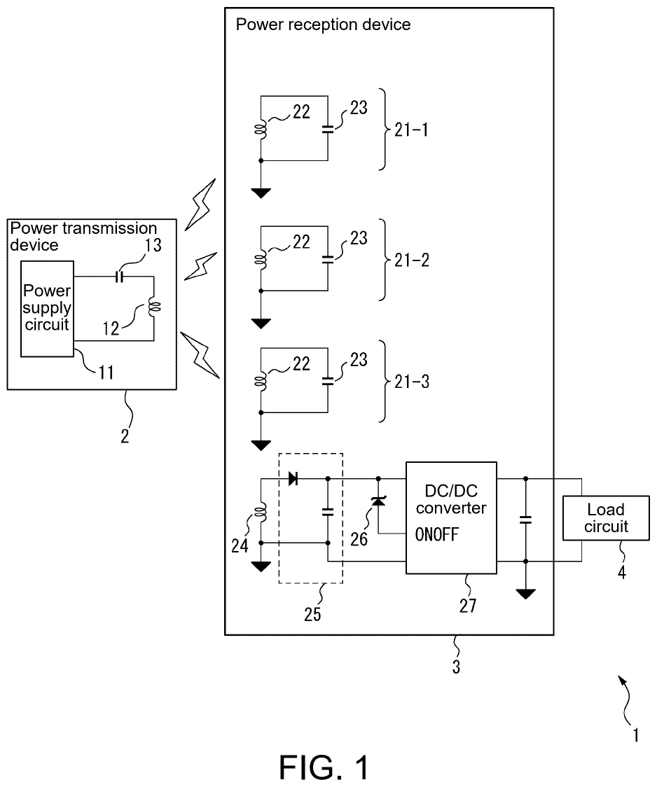

FIG. 1 is a schematic configuration diagram of a non-contact power supply device according to an embodiment of the invention. As shown in FIG. 1, a non-contact power supply device 1 has a power transmission device 2 and a power reception device 3 to which power is transmitted in a non-contact manner from the power transmission device 2 via space. The power transmission device 2 has a power supply circuit 11, a transmission coil 12, and a capacitor 13. On the other hand, the power reception device 3 has n resonant circuits 21-1 to 21-n (where n is an integer of 2 or more, and in the example shown in FIG. 1, n=3), a load coil 24, a rectifier smoothing circuit 25, a voltage detection circuit 26, and a DC-DC converter 27, and outputs power received from the power transmission device 2 to a load circuit 4. In the embodiment, the non-contact power supply device 1 is a non-contact power supply device of an NP-type, which is a type that does not utilize primary side resonance and in which the reception coils and the resonant capacitors perform parallel resonance on the secondary side. However, the non-contact power supply device 1 may also be a device conforming to other non-contact power supply methods, such as an SP-type in which the transmission coil 12 and the capacitor 13 perform serial resonance on the primary side and the reception coils and the resonant capacitors perform parallel resonance on the secondary side.

First, the power transmission device 2 will be described.

The power supply circuit 11 supplies AC power to the transmission coil 12. For this purpose, the power supply circuit 11 has, for example, a DC power source that supplies DC power, an inverter circuit that converts the DC power supplied from the DC power source into AC power and supplies the AC power to the transmission coil 12, and a control circuit that controls the inverter circuit. The inverter circuit may be a full bridge inverter in which four switching elements (for example, MOSFETs) are connected in a full bridge configuration, or may be a half-bridge inverter in which two switching elements are connected in a half-bridge configuration. Alternatively, the inverter circuit may have the same configuration as a class E amplifier. The control circuit controls ON/OFF switching of each switching element included in the inverter circuit, so that the frequency of the AC power supplied to the transmission coil 12 becomes a predetermined frequency (for example, a frequency at which each resonant circuit is able to resonate in the case where the coupling degree between the reception coil of each resonant circuit of the power reception device 3 and the transmission coil 12 is a predetermined value). The power supply circuit 11 may further have a DC-DC converter between the DC power source and the inverter circuit.

The transmission coil 12 transmits the AC power supplied from the power supply circuit 11 to the resonant circuits 21-1 to 21-n of the power reception device 3 via space by electromagnetically coupling with the reception coil of each resonant circuit of the power reception device 3.

The capacitor 13 is connected in series with the transmission coil 12 between the transmission coil 12 and the inverter circuit of the power supply circuit 11. In the embodiment, the capacitor 13 is provided to block DC power. Therefore, the capacitance of the capacitor 13 is set, so that the resonant circuit constituted by the transmission coil 12 and the capacitor 13 does not resonate with respect to the AC power supplied to the transmission coil 12, that is, so that the frequency of the AC power supplied to the transmission coil 12 and the resonant frequency of the resonant circuit are different. In the case where the power supply circuit 11 has a full bridge inverter, the capacitor 13 may be omitted.

Next, the power reception device 3 will be described.

Each of the n resonant circuits 21-1 to 21-n has a reception coil 22 and a resonant capacitor 23.

In the embodiment, in each of the resonant circuits 21-1 to 21-n, the reception coil 22 and the resonant capacitor 23 are connected in parallel. In each of the resonant circuits 21-1 to 21-n, the reception coil 22 and the resonant capacitor 23 form a closed loop. Furthermore, the inductances of the reception coils 22 and the capacitances of the resonant capacitors 23 in the respective resonant circuits 21-1 to 21-n can make the products of the inductances and capacitances of the respective resonant circuits equal to each other, and are set so that each resonant circuit can resonate with respect to the AC power supplied to the transmission coil 12. For example, the inductances of the reception coils 22 in the respective resonant circuits 21-1 to 21-n are set to be the same as each other, and the capacitances of the resonant capacitors 23 in the respective resonant circuits 21-1 to 21-n are set to be the same as each other.

Furthermore, the reception coil 22 of each of the resonant circuits 21-1 to 21-n is arranged to be able to be electromagnetically coupled with the load coil 24. Therefore, in the case where the power transmission device 2 and the power reception device 3 are in a positional relationship capable of transmitting power from the power transmission device 2 to the power reception device 3, the reception coil 22 of each of the resonant circuits 21-1 to 21-n resonates together with the resonant capacitor 23 and electromagnetically couples with the transmission coil 12, whereby each resonant circuit receives power from the transmission coil 12. Furthermore, the power received by each of the resonant circuits 21-1 to 21-n is output via the load coil 24.

The load coil 24 is arranged to be able to be electromagnetically coupled with the reception coil 22 of each of the resonant circuits 21-1 to 21-n. Both ends of the load coil 24 are connected to the rectifier smoothing circuit 25. Therefore, the power received by each of the resonant circuits 21-1 to 21-n from the power transmission device 2 is output from the load coil 24 to the load circuit 4 via the rectifier smoothing circuit 25 and the DC-DC converter 27.

The rectifier smoothing circuit 25 is connected between the load coil 24 and the DC-DC converter 27, rectifies the power output from the load coil 24, and smooths and converts the power to DC power. The rectifier smoothing circuit 25 outputs the DC power obtained by conversion to the DC-DC converter 27. In the embodiment, the rectifier smoothing circuit 25 includes a half-wave rectifier circuit configured by one diode connected to one end of the load coil 24 on a side opposite to the grounded side, and a smoothing capacitor that smooths the power rectified by the half-wave rectifier circuit on the output side of the half-wave rectifier circuit. By configuring the rectifier smoothing circuit 25 as a half-wave rectifier circuit in this manner, the potential at the output terminal on the negative electrode side of the rectifier smoothing circuit 25 and the potential at one end of the reception coil 22 of each of the resonant circuits 21-1 to 21-n and one end of the load coil 24 can be set to be the same potential. Therefore, it becomes possible to ground one end of the reception coil 22 of each of the resonant circuits 21-1 to 21-n and one end of the load coil 24. As a result, it becomes possible to improve the resistance of the power reception device 3 against noise.

The voltage detection circuit 26 is connected between the rectifier smoothing circuit 25 and the DC-DC converter 27, and turns on the DC-DC converter 27 when the voltage output from the rectifier smoothing circuit 25 exceeds a predetermined threshold. In the embodiment, the voltage detection circuit 26 is configured by a Zener diode. The anode terminal of the Zener diode is connected to the ON/OFF control terminal of the DC-DC converter 27, and the cathode terminal is connected to the output terminal on the positive electrode side of the rectifier smoothing circuit 25. Therefore, in the case where the voltage output from the rectifier smoothing circuit 25 is equal to or less than the breakdown voltage of the Zener diode (corresponding to the predetermined threshold), a relatively low voltage is applied to the ON/OFF control terminal of the DC-DC converter 27, so the DC-DC converter 27 is turned off. Comparatively, when the voltage output from the rectifier smoothing circuit 25 exceeds the breakdown voltage of the Zener diode, a relatively high voltage corresponding to the voltage output from the rectifier smoothing circuit 25 is applied to the ON/OFF control terminal of the DC-DC converter 27, so the DC-DC converter 27 is turned on and operates so that the output power becomes constant. The voltage detection circuit 26 is not limited to the above example, and may have other circuit configurations capable of turning on the DC-DC converter 27 when the output voltage from the rectifier smoothing circuit 25 exceeds a predetermined threshold.

The DC-DC converter 27 is connected between the rectifier smoothing circuit 25 and the load circuit 4. When a voltage for turning on is applied to the ON/OFF control terminal, the DC-DC converter 27 converts the voltage input via the rectifier smoothing circuit 25 to step up or step down so that the power output from the DC-DC converter 27 becomes constant, and outputs DC power having the converted voltage to the load circuit 4 via a smoothing capacitor connected between the DC-DC converter 27 and the load circuit 4. Also, when a voltage for turning off is applied to the ON/OFF control terminal, the DC-DC converter 27 stops power output to the load circuit 4. To improve power transmission efficiency, the DC-DC converter 27 is preferably a step-down type DC-DC converter. However, the DC-DC converter 27 may also be a step-up type or step-up/step-down type DC-DC converter as long as the DC-DC converter 27 can output a voltage at which the load circuit 4 operates.

Hereinafter, the arrangement of the reception coil 22 of each the resonant circuits 21-1 to 21-n and the load coil 24 will be described.

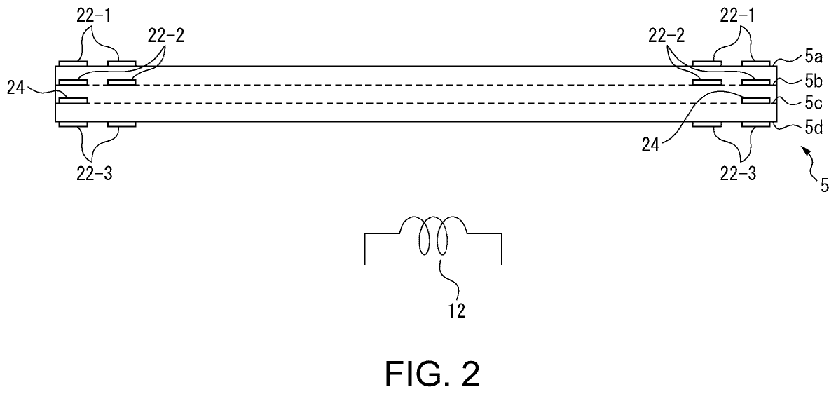

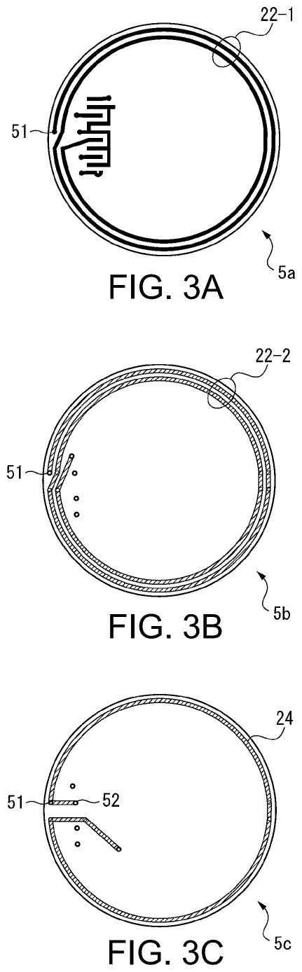

FIG. 2 is a schematic side cross-sectional view of the substrate 5 on which the reception coil 22 of each of the resonant circuits 21-1 to 21-n and the load coil 24 are arranged. Also, FIG. 3A to FIG. 3D are schematic plan views showing the arrangement of individual reception coils 22 and the load coil 24 in the respective layers 5a to 5d of the substrate 5, as viewed from the normal direction of the surface of the substrate 5. In FIG. 3A to FIG. 3D, the illustration of wiring patterns other than the individual resonant circuits 21-1 to 21-n and the load coil 24 is omitted. In this example, the power reception device 3 has three resonant circuits (that is, n=3). Furthermore, in FIG. 2 and FIG. 3A to FIG. 3D, the reception coils of the resonant circuits 21-k (k=1, 2, 3) are respectively denoted as reception coils 22-k.

As shown in FIG. 2, the substrate 5 formed of an insulator is, for example, a substrate having a thickness of about 1 mm to several mm, and has multiple layers 5a to 5 d. The reception coil 22-k of each resonant circuit 21-k and the load coil 24 are arranged in mutually different layers among the respective layers of the substrate 5. In this example, the load coil 24 is arranged in the second layer 5c in an order from the side closer to the transmission coil 12 during power transmission. However, the layer in which the load coil 24 is arranged is not limited to this example, and the load coil 24 may also be arranged in any of the layer 5a farthest from the transmission coil 12, the layer 5d closest to the transmission coil 12, or another intermediate layer 5b.

Also, as shown in FIG. 3A to FIG. 3D, the respective reception coils 22-k and the load coil 24 are formed as wiring patterns having a line width of less than 1 mm to several mm in different layers of the substrate 5, so as to be coaxial and preferably have equal outer diameters. By arranging the respective reception coils 22-k and the load coil 24 in this manner, the respective reception coils 22-k and the load coil 24 can be electromagnetically coupled to each other. One end of each of the reception coils 22-k and one end of the load coil 24 are connected to each other via a via 51 provided in the substrate 5. Therefore, the end of each of the reception coils 22-k and the end of the load coil 24 have the same potential. By forming the respective reception coils 22-k and the load coil 24 in this manner, it becomes unnecessary to provide a lead wire for each of these coils, so wiring is simplified. Since a greater voltage is applied to the load coil 24 than to each of the resonant circuits 21-k, the width of the wiring pattern of the load coil 24 is preferably wider than the width of the wiring pattern of each of the reception coils 22-k, so as to reduce loss.

Furthermore, in the layer 5c where the load coil 24 is provided, one end of the load coil 24 is connected to a grounded via 52. Therefore, one end of each of the reception coils 22-k and one end of the load coil 24 are grounded. As a result, the influence due to noise is suppressed. On the other hand, the other ends of the respective reception coils 22-k are provided to be separated from each other. In the example shown in FIG. 3A to FIG. 3D, the other end of each of the reception coils 22-k is connected to the one end of a corresponding resonant capacitor provided in the layer 5a via a via. The reasons are as follows. That is, since the reception coils 22-k of the respective resonant circuits 21-k are provided in mutually different layers of the substrate 5, the coupling degree with respect to the transmission coil 12 differs slightly for each resonant circuit 21-k. As a result, the voltage of the power received by each of the resonant circuits 21-k also differs slightly. Here, when the other ends of the respective reception coils 22-k are also connected to each other, a current corresponding to the voltage difference generated from the resonant circuit that generates the highest voltage among the respective resonant circuits 21-k to the other resonant circuits may flow, and as a result, power transmission efficiency may decrease. However, as in the embodiment, by separating the other ends of the respective reception coils 22-k from each other, such current flow between resonant circuits is prevented, so the decrease in power transmission efficiency is suppressed.

Furthermore, the number of turns of the load coil 24 is preferably smaller than the total number of turns of the respective reception coils 22. In particular, the number of turns of the load coil 24 is preferably 1 turn or less than 1 turn (for example, 0.5, 0.6, or 0.8 turns, etc.).

In the embodiment, each of the resonant circuits 21-k is configured so that the reception coil 22 and the resonant capacitor form parallel resonance. In the case where such parallel resonance is utilized for power transmission, it is known that the resistance of the load connected to the resonant circuit, which optimizes power transmission efficiency, becomes a relatively large value. Furthermore, in the embodiment, since the reception coil 22 of each of the resonant circuits 21-k and the load coil 24 are arranged to be capable of being electromagnetically coupled with each other, the power reception device 3 can be represented by an equivalent circuit that receives power with one resonant circuit and outputs the received power to a load. An equivalent resistance R″ of the load in the equivalent circuit (hereinafter referred to as equivalent load for the ease of description) is a value obtained by multiplying an equivalent resistance R′ of the load connected to the load coil 24 by the square of a ratio m of the total number of turns of the reception coils 22 of the respective resonant circuits 21-k to the number of turns of the load coil 24. In the examples shown in FIG. 2 and FIG. 3A to FIG. 3D, the number n of the resonant circuits is 3. Furthermore, the number of turns of each of the reception coils 22-k is 2, and the number of turns of the load coil 24 is 1. Therefore, m=(3*2)²=36. Accordingly, the equivalent resistance R″ of the equivalent load becomes m²*R′=36*R′. In this manner, as the value of the ratio m becomes larger, the equivalent resistance R″ of the equivalent load becomes larger, so the optimization of the power transmission efficiency can be simplified. Therefore, by setting the relationship between the number of turns of each of the reception coils 22 and the number of turns of the load coil 24 as described above, the optimization of power transmission efficiency is facilitated. Furthermore, by setting the number of turns of the load coil 24 to 1 turn or less than 1 turn, it becomes easy to connect one end of the load coil 24 to the via 52 that is grounded. Moreover, even in the case where the number of turns of the reception coil 22-k of each resonant circuit is 2 or more, it becomes easy to ground one end of the reception coils 22-k via the vias 51 connected to the load coil 24.

Furthermore, in the embodiment, since the load circuit 4 is connected via the DC-DC converter 27, the equivalent resistance R′ of the load connected to the load coil 24 becomes a value obtained by multiplying the resistance R of the load circuit 4 by the square of the ratio (Vo/Vin) of the output voltage Vo from the DC-DC converter 27 to the input voltage Vin to the DC-DC converter 27 (i.e., R′=R*(Vo/Vin)²). Therefore, with the DC-DC converter 27 performing step-down operation, it becomes possible to make the equivalent resistance R″ greater than the resistance R of the load circuit 4, thereby making it easier to optimize power transmission efficiency.

Also, to keep the output power constant, the DC-DC converter 27 operates so that the lower the input voltage Vin, the higher the duty ratio of the switching element that the DC-DC converter 27 has becomes. The higher the duty ratio becomes, the more the average value of the current flowing to the input side of the DC-DC converter 27 increases, and the equivalent resistance R′ decreases. Therefore, when the input voltage Vin decreases, the output power from the DC-DC converter 27 does not reach the target power value, and the operation of the DC-DC converter 27 may become unstable. Alternatively, in the case where there are multiple operation conditions under which the output voltage from the DC-DC converter 27 becomes constant, the lower the input voltage Vin, the easier it becomes to converge to the operation condition with the smaller equivalent resistance R′ among the multiple operation conditions. Alternatively, the higher the input voltage Vin, the more the DC-DC converter 27 operates such that the duty ratio of the switching element becomes lower, so the equivalent resistance R′ becomes larger. Therefore, as described above, by turning on the DC-DC converter 27 when the voltage output from the rectifier smoothing circuit 25 exceeds a predetermined threshold, it becomes possible to stabilize the operation of the DC-DC converter 27 and operate the DC-DC converter 27 under the operation condition in which the equivalent resistance R′ becomes larger. As a result, it becomes possible to improve power transmission efficiency.

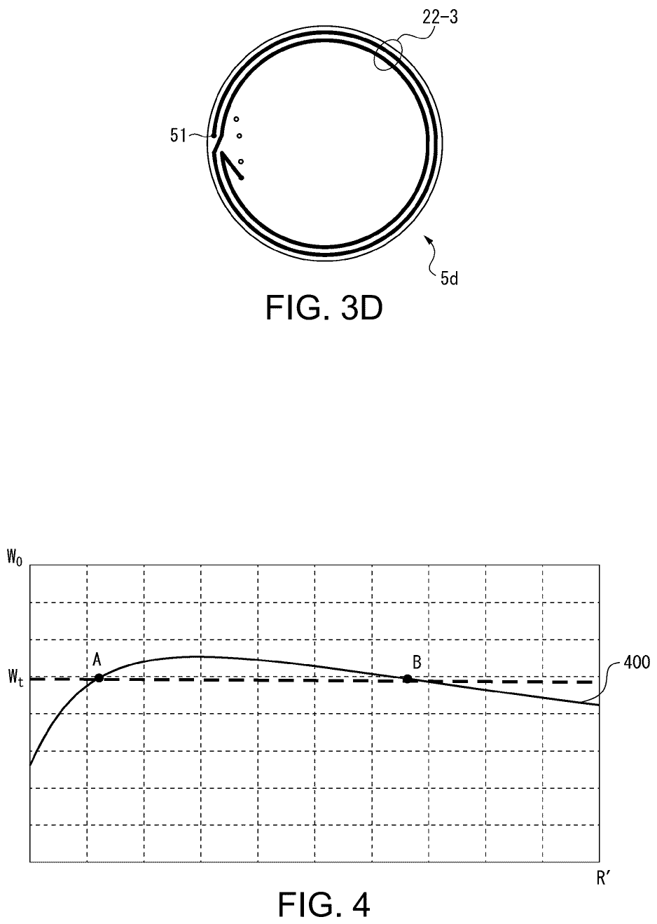

FIG. 4 is a diagram showing an example of operating properties of the DC-DC converter 27. In FIG. 4, the horizontal axis represents the equivalent resistance R′, and the vertical axis represents the output power Wo from the DC-DC converter 27. A graph 400 represents the relationship between the equivalent resistance R′ and the output power Wo due to the operation of the DC-DC converter 27. As shown in the graph 400, there are two points (operation points A and B) of equivalent resistance R′ where the output power Wo becomes the target output power Wt. As described above, when the input voltage Vin is low, the DC-DC converter 27 operates such that the equivalent resistance R′ becomes low, so the DC-DC converter 27 operates to approach the operation point A where the value of the equivalent resistance R′ is lower. Comparatively, when the input voltage Vin is sufficiently high (i.e., higher than a predetermined threshold), it becomes possible to operate the DC-DC converter 27 to approach the operation point B where the value of the equivalent resistance R′ is higher. As a result, it becomes possible to increase the equivalent resistance R″ of the equivalent load, and it becomes possible to improve the power transmission efficiency.

As described above, the power reception device of the non-contact power supply device includes multiple resonant circuits capable of resonating with respect to the AC power supplied to the transmission coil of the power transmission device, and the load coil that extracts power received in each of the resonant circuits. The reception coil of each of the resonant circuits and the load coil are formed by wiring patterns in mutually different layers of the multi-layered substrate, and the reception coil of each of the resonant circuits and the load coil are connected so that one end of the reception coil of each of the resonant circuits and one end of the load coil have the same potential. Therefore, this non-contact power supply device can simplify the wiring of the power reception device. Additionally, according to the power reception device receiving power through multiple resonant circuits, an excessive increase in the voltage across the resonant capacitor terminals of the respective resonant circuits is suppressed.

According to a modified example, the rectifier smoothing circuit 25 of the power reception device 3 may include a full-wave rectifier circuit in which four diodes are connected in a full-bridge configuration, instead of a half-wave rectifier circuit having one diode. In this case, the potential of each of the terminals on the output side of the rectifier smoothing circuit 25 connected to the load circuit 4 differs from the potential of the one end of the reception coil 22 of each of the resonant circuits and the one end of the load coil 24 that are connected to each other. Therefore, when the one end of the load circuit 4 is grounded, the one end of the reception coil 22 of each of the resonant circuits and the one end of the load coil 24 do not become grounded. Additionally, in the case assuming that the voltage output from the rectifier smoothing circuit 25 of the power reception device 3 becomes a voltage at which the load circuit 4 can operate during power transmission, the voltage detection circuit 26 and the DC-DC converter 27 may be omitted.

Thus, those skilled in the art can make various modifications according to the implemented forms within the scope of the invention.

### REFERENCE SIGNS LIST

1 Non-contact power supply device
2 Power transmission device
11 Power supply circuit
12 Transmission coil
13 Capacitor
3 Power reception device
4 Load circuit
5 Substrate
51,52 Via
21-1 to 21-n Resonant circuit
22, 22-1 to 22-3 Reception coil
23 Resonant capacitor
24 Load coil
25 Rectifier smoothing circuit
26 Voltage detection circuit

1. A non-contact power supply device, comprising: a power transmission device; and a power reception device to which power is transmitted from the power transmission device in a non-contact manner,
wherein the power transmission device comprises:
a transmission coil, supplying power to the power reception device; and
a power supply circuit, supplying AC power to the transmission coil,
the power reception device comprises:
a plurality of resonant circuits, the resonant circuit having a reception coil and a resonant capacitor and receiving power from the power transmission device through resonance of the reception coil and the resonant capacitor with respect to the AC power supplied to the transmission coil of the power transmission device; and
a load coil, arranged to be able to be electromagnetically coupled to the reception coil of each of the resonant circuits and outputting the power received by each of the resonant circuits from the power transmission device, and
the reception coil of each of the resonant circuits and the load coil are formed as wiring patterns in layers different from each other in a substrate having a plurality of layers, and an end of the reception coil of each of the resonant circuits and an end of the load coil are connected to each other to have a same potential.

2. The non-contact power supply device as claimed in claim 1, wherein the end of the reception coil of each of the resonant circuits and the end of the load coil are grounded.

3. The non-contact power supply device as claimed in claim 1, wherein other ends of the reception coils of the respective resonant circuits are separated from each other.

4. The non-contact power supply device as claimed in claim 1, wherein a number of turns of the load coil is smaller than a total number of turns of the reception coils of the respective resonant circuits.

5. The non-contact power supply device as claimed in claim 1, wherein the power reception device further comprises:
a DC-DC converter, operating to step down or step up a voltage output from the load coil; and
a voltage detection circuit, operating the DC-DC converter when the voltage output from the load coil exceeds a predetermined threshold.

6. A power reception device, receiving power transmitted from a transmission coil of a power transmission device in a non-contact manner, the power reception device comprising:
a plurality of resonant circuits, the resonant circuit having a reception coil and a resonant capacitor and receiving power from the power transmission device through resonance of the reception coil and the resonant capacitor with respect to AC power supplied to the transmission coil of the power transmission device; and
a load coil, arranged to be able to be electromagnetically coupled to the reception coil of each of the resonant circuits and outputting the power received by each of the resonant circuits from the power transmission device, and
the reception coil of each of the resonant circuits and the load coil are formed as wiring patterns in layers different from each other in a substrate having a plurality of layers, and an end of the reception coil of each of the resonant circuits and an end of the load coil are connected to each other to have a same potential.

7. The non-contact power supply device as claimed in claim 2, wherein other ends of the reception coils of the respective resonant circuits are separated from each other.

8. The non-contact power supply device as claimed in claim 2, wherein a number of turns of the load coil is smaller than a total number of turns of the reception coils of the respective resonant circuits.

9. The non-contact power supply device as claimed in claim 2, wherein the power reception device further comprises:
a DC-DC converter, operating to step down or step up a voltage output from the load coil; and
a voltage detection circuit, operating the DC-DC converter when the voltage output from the load coil exceeds a predetermined threshold.
